(19) United States
(12) Patent Application Publication
(10) Pub. No.: US 2023/0396119 A1
(43) Pub. Date: Dec. 7, 2023

(54) ELECTRICAL DRIVE UNIT

(71) Applicant: Rolls-Royce Deutschland Ltd & Co KG, Blankenfelde-Mahlow (DE)

(72) Inventors: Lukas SOBOTTA, Erlangen (DE); Jan Magnus FARSTAD, Trondheim (NO); Maria BØE, Trondheim (NO); Niklas SCHAMBERGER, Nürnberg (DE)

(21) Appl. No.: 18/203,843

(22) Filed: May 31, 2023

(30) Foreign Application Priority Data
May 31, 2022 (DE) 10 2022 113 634.5

(51) Int. Cl. H02K 5/18; H02K 11/33

(52) U.S. Cl. CPC H02K 5/18; H02K 2211/03; H02K 11/33

(57) ABSTRACT

The disclosure relates to an electric drive unit that includes: a motor housing that surrounds an electric motor and has an external side; cooling fins configured on the external side of the motor housing; and an electrical module having components to be cooled. The electrical module is disposed in or on an additional housing that adjoins the motor housing, wherein the additional housing on the external side thereof has cooling fins that run in the same direction as the cooling fins of the motor housing.

The present patent document claims the benefit of German Patent Application No. 10 2022 113 634.5, filed May 31, 2022, which is hereby incorporated by reference in its entirety.

### TECHNICAL FIELD

The disclosure relates to an electric drive unit.

### BACKGROUND

An electric drive unit includes an electric motor that may be surrounded by a motor housing. Such a motor housing may simultaneously serve as a cooling member for the electric motor, in which case the motor housing on the external side thereof is provided with cooling fins.

Electric drive units furthermore include electrical components such as, for example, power semiconductors, which likewise have to be cooled.

### SUMMARY AND DESCRIPTION

The disclosure is based on the object of providing an electric drive unit configured to cool its components in an effective way.

This object is achieved by an electric drive unit as described herein. The scope of the present disclosure is defined solely by the appended claims and is not affected to any degree by the statements within this summary. The present embodiments may obviate one or more of the drawbacks or limitations in the related art.

Accordingly, an electric drive unit is disclosed. The electric drive unit includes a motor housing that surrounds an electric motor and has an external side. Cooling fins are configured on the external side of the motor housing. The electric drive unit furthermore includes an electrical module having components to be cooled.

The electrical module is disposed in or on an additional housing that adjoins the motor housing, wherein the additional housing on the external side thereof has cooling fins that run in the same direction as the cooling fins of the motor housing.

The disclosure is based on the concept of providing an additional housing for disposing and cooling an electrical module, the additional housing acting as a cooling member and discharging heat in that the additional housing on the external side thereof configures cooling fins that run in the same direction as the cooling fins of the motor housing. It is made possible as a result that the additional housing is cooled by the same airflow as the motor housing. It is thus no longer necessary to direct cooling air separately about a plurality of cooling members. The complexity of the overall construction is reduced as a result.

A further advantage associated with the disclosure lies in that by integrating the electrical module in the additional housing, the electrical module may be disposed close to the electric motor so that connecting cables, etc., may be configured to be short, there are fewer losses, and a high degree of integration of the components of the electric drive unit is provided.

It is pointed out that the additional housing adjoins the motor housing. It is provided here that the additional housing is directly contiguous to the motor housing such that there is no gap in between. The additional housing and the motor housing may be connected, (e.g., screwed), to one another.

In an embodiment, the cooling fins of the additional housing are aligned with the cooling fins of the motor housing. The geometry of the cooling fins of the motor housing and of the additional housing may be identical here. The cooling fins of the motor housing are extended into the additional housing, so to speak. The motor housing represents a cooling member that, by way of cooling fins that are configured on the external side of the cooling member, cools the electric motor surrounded by the motor housing. As a result of the cooling fins of the additional housing being aligned with the cooling fins of the motor housing, the respective cooling fins are thermally coupled so that the motor housing and the additional housing are also thermally coupled. A cooling member composed of the motor housing and the additional housing and co-aligned cooling fins is achieved as a result.

In an embodiment, components of the electrical module are disposed on at least one circuit board disposed on or integrated in the additional housing. If the components of the electrical module are disposed on at least two circuit boards, the circuit boards may be mutually disposed at an angle in or on the additional housing so as to achieve an adaptation to a circular housing geometry. In comparison to a circuit board assembly in which all circuit boards are disposed radially on top of one another, a more compact construction mode is achieved as a result. The diameter of the drive unit is in particular reduced by an angular arrangement of the circuit boards.

In another embodiment, components of the electrical module that have to be cooled are disposed on that side of the circuit board that faces the external side of the additional housing. As a result, particularly effective cooling of these components may take place because the external side is imparted cooling by the cooling fins.

In a further embodiment, the motor housing as well as the additional housing include an at least partially circular housing wall, wherein the housing walls of the motor housing and of the additional housing have the same external radius. It is made possible as a result that the respective cooling fins are co-aligned.

If at least two circuit boards are mutually disposed at an angle in the additional housing, the circuit boards according to one embodiment are completely integrated in the housing wall, i.e., the circuit boards do not protrude beyond the housing wall either toward the inside or the outside.

In a further embodiment, the housing wall of the additional housing configures at least one planar shelf area on which bears a circuit board, wherein the external side of the additional housing extends radially outside the planar shelf area and the circuit board in a circular manner. By providing a planar shelf area, it is made possible that the circuit board is disposed in the housing wall without flexing. The circuit board here is embedded in the housing wall, so to speak, wherein the outward-directed side of the circuit board is contiguous to the external side of the additional housing and is cooled by the latter.

In one further embodiment, the electric contacts of the electrical module are disposed on the front end of the additional housing that faces away from the motor housing. Ease of access to the contacts is ensured as a result. The contacts are, for example, DC contacts which connect the electrical module to a battery. Further contacts that serve for controlling the electrical module, for example, and/or for communicating with the electrical module may additionally be provided.

In an embodiment, the motor housing and the additional housing are composed of the same material. The material used is in particular a metal or a metal alloy, for example, aluminum or an aluminum alloy.

The additional housing and the motor housing are capable of being screwed to one another, for example. In principle, there are numerous possibilities for connecting the motor housing and the additional housing to one another, alternatively by adhesive bonding or by way of a flange connection, for example.

A further design embodiment provides that the motor housing has a longitudinal direction, wherein the cooling fins of the motor housing and of the additional housing run in the longitudinal direction. The cooling fins extend in each case in a rectilinear manner. Alternatively, the cooling fins run in a rectilinear manner so as to be at an angle to the longitudinal direction.

The electrical module may be any arbitrary electrical module of an electric drive unit. According to one embodiment, the electrical module is an inverter which has power semiconductors as components to be cooled. The inverter receives DC from a battery and provides the electric motor with AC.

The electric motor surrounded by the motor housing may be of any arbitrary construction mode. In certain embodiments, the electric motor is a permanent magnet synchronous motor. In the case of a permanent magnet synchronous motor, the stator is occupied by coils, while surface magnets are attached to the rotor. The AC voltage provided by an inverter impinges the stator coils.

### BRIEF DESCRIPTION OF THE DRAWINGS

The disclosure is explained in more detail hereunder with reference to the drawings, and by a plurality of exemplary embodiments. In the drawings:

FIG. 1 depicts an embodiment of an electric drive unit in a perspective view, having a motor housing and connected thereto an additional housing, the housing configuring co-aligned cooling fins;

FIG. 2 depicts an enlarged illustration of a sub-region of the electric drive unit of FIG. 1; and

FIG. 3 depicts an example of a plurality of circuit boards in a schematic illustration, having disposed thereon electrical components that are integrated in the housing wall of an additional housing according to FIG. 1.

### DETAILED DESCRIPTION

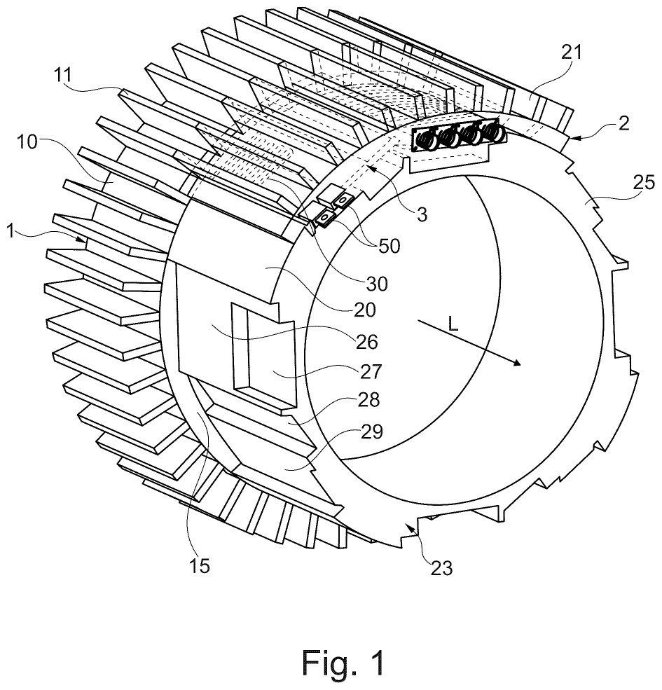

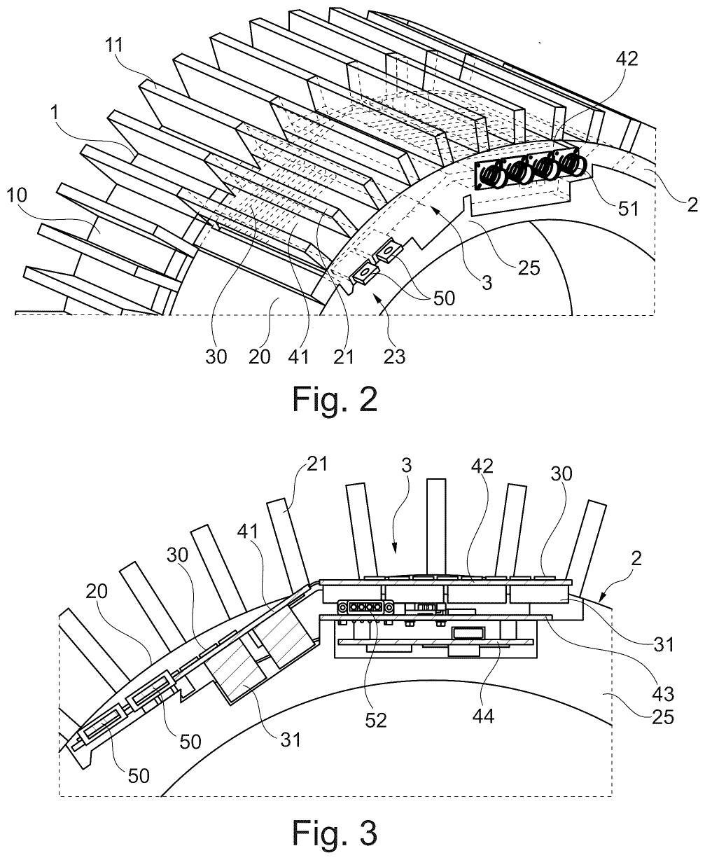

FIGS. 1 and 2 show an exemplary embodiment of an electric drive unit in a perspective illustration, whereby FIG. 2 represents an enlarged illustration of the upper region of FIG. 1. The electric drive unit includes a motor housing 1 and an additional housing 2. The motor housing 1 surrounds an electric motor, not illustrated, and includes a housing wall 15 having an external side 10. Cooling fins 11 are configured on the external side 10 of the motor housing 1, wherein the cooling fins 11 run in a longitudinal direction L and are disposed along the circumference of the motor housing 1. The cooling fins 11 here run parallel to one another. The longitudinal direction L is defined by the rotation axis of a rotor of the electric motor.

The exact type of the electric motor surrounded by the motor housing 1 is not relevant to the present disclosure. In principle, the electric motor may be implemented in any arbitrary construction mode.

It is pointed out that the axial length of the motor housing 1 is illustrated so as to be shortened in FIG. 1. The motor housing 1 may have a greater axial length. Accordingly, the cooling fins 11 also run across a greater axial length.

The additional housing 2 has a housing wall 25 having an external side 20. Cooling fins 21 extend in the same direction as the cooling fins 11 of the motor housing 1 and are configured on the external side 20 of the additional housing 2. The cooling fins 21 of the additional housing 2 are aligned with the cooling fins 11 of the motor housing 1, the cooling fins 21 of the additional housing 2 thus representing an extension of the cooling fins 11 of the motor housing 1. The cooling fins 11, 21 here have identical heights and widths in this particular example, but are not limited to this arrangement. For example, it may alternatively be provided that the cooling fins 21 of the additional housing 2 are of a lesser or greater height or width than the cooling fins 11 of the motor housing 1.

In one alternative embodiment, the cooling fins 11, 21 of the motor housing 1 and of the additional housing 2 are not co-aligned but run in the same direction L. In this case, the respective cooling fins 11, 21 are disposed so as to be mutually offset in the circumferential direction.

The cooling fins 11, 21 of the motor housing 1 and of the additional housing 2 may also run in a direction that runs obliquely to the longitudinal direction L, as long as the cooling fins 11, 21 run in the same direction.

The motor housing 1 and the additional housing 2 directly adjoin one another in the longitudinal direction so that there is no gap in between. To this end, the additional housing 2 is screwed to the motor housing 1, for example, whereby other fastening methods are also possible. As a result of the connection between the motor housing 1 and the additional housing 2, the respective cooling fins 11, 21 also directly adjoin one another so that the cooling fins 11, 21 are cooled by the same airflow. The motor housing 1 and the additional housing 2 form a common cooling structure. The motor housing and the additional housing are composed of aluminum, for example, or an aluminum alloy.

An electrical module 3 is integrated in the additional housing 2. For improved visibility of the electrical module 3, the upper housing half of the additional housing 2 is illustrated so as to be transparent in FIGS. 1 and 2. The electrical module 3 forms an inverter, for example, which provides the electric motor with AC. This is however to be understood merely as an example. The electrical module 3 includes components that have a high power loss and therefore require cooling. The construction and the arrangement of the electrical module 3 is explained in more detail hereunder by FIG. 3.

FIG. 3 schematically shows the components of an electrical module 3 in a frontal view and in an enlarged illustration. The components are disposed on two circuit boards 41, 42, which for adaptation to the circular motor geometry are mutually disposed at an angle and thereby are completely integrated in the circular housing wall 25 of the additional housing 2. The electrical module 3 here includes components 30 that have to be cooled and are disposed on a side of the circuit boards 41, 42 that faces the external side 20 of the additional housing 2. The components 30 are power semiconductors, for example.

The electrical module 3 furthermore includes further components 31. The latter in part may be disposed on further circuit boards 43, 44 that run parallel to the circuit board 42. Such an arrangement is however to be understood merely as an example. The further components 31 have less power loss and therefore do not require cooling, or only less cooling, so that the further components 31 are disposed on that side of the circuit boards 41, 42 that faces the interior of the additional housing 2.

As may be seen in FIGS. 2 and 3, electric contacts 50, which serve for feeding DC that is provided from a battery not illustrated, are configured on the front end 23 of the additional housing 2 that faces away from the motor housing 1. Further contacts 51, 52 by way of which control signals are transmitted, for example, may furthermore be provided.

Referring again to FIG. 1, it is pointed out that only one electrical module 3 is illustrated in the upper region of the additional housing 2 in FIG. 1. Further electrical modules along the circumference of the additional housing 2 are integrated in an analogous manner in the additional housing 2 and covered by the external face 20 of the additional housing 2 having the cooling fins 21. If the electrical modules 3 form inverters, four inverters are distributed uniformly across the circumference, for example. Such a design embodiment having four inverters permits a redundant operation of an electric motor.

The housing wall 25 of the additional housing for receiving the circuit boards 41, 42 and the components fastened thereto configures planar shelf areas that extend within the housing wall 25 and on which the 2D circuit boards may be disposed without the latter flexing. In FIG. 1, this may be seen in such regions of the additional housing 2 in which the circuit boards 41, 42 and the external cooling fins 21 are not illustrated but are likewise present. In this way, the housing wall 25 configures inner shelf areas 26, 27, 28, 29 for circuit boards corresponding to the circuit boards 41, 42 of FIG. 3. The external side 20 of the additional housing 2, on which the cooling fins 21 are configured, extends in each case radially outside the planar shelf areas 26, 27, 28, 29 and the circuit boards disposed thereon. In the completely assembled state of the electric drive unit, the cooling fins 21, like the cooling fins 11 of the motor housing 1, extend over the entire circumference of 360°.

The circuit boards 41, 42 here are completely integrated in the housing wall 25 of the additional housing 2. In this way, short cables from the electrical module 3 to the electric motor may be implemented in a space-saving manner.

It is pointed out that the present disclosure may be used in numerous applications. In one exemplary embodiment, the drive unit according to the disclosure is used with electric motors for aerospace drives.

It is understood that the disclosure is not restricted to the embodiments described above, and various modifications and improvements may be undertaken without departing from the concepts described here. It is furthermore pointed out that any of the features described may be used separately or in combination with any other features, to the extent that the features are not mutually exclusive. The disclosure extends to and includes all combinations and sub-combinations of one or a plurality of features that are described here. If ranges are defined, the ranges thus include all of the values within the ranges as well as all of the partial ranges that lie within a range.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An electric drive unit comprising:
a motor housing that surrounds an electric motor and has an external side,
cooling fins positioned on the external side of the motor housing, and
an electrical module having components to be cooled, wherein the electrical module is disposed in or on an additional housing that adjoins the motor housing,
wherein additional cooling fins are positioned on an external side of the additional housing,
wherein the additional cooling fins of the additional housing run in a same direction as the cooling fins of the motor housing.

2. The electric drive unit of claim 1, wherein the additional cooling fins of the additional housing are aligned with the cooling fins of the motor housing.

3. The electric drive unit of claim 1, wherein the components of the electrical module are disposed on at least one circuit board which that is disposed on or integrated in the additional housing.

4. The electric drive unit of claim 1, wherein the components of the electrical module are disposed on at least two circuit boards, and
wherein the at least two circuit boards are mutually disposed at an angle in or on the additional housing.

5. The electric drive unit of claim 3, wherein the components of the electrical module that are to be cooled are disposed on a side of the at least one circuit board that faces the external side of the additional housing.

6. The electric drive unit of claim 1, wherein the motor housing and the additional housing each comprise an at least partially circular housing wall, and
wherein the housing wall of the motor housing and the housing wall of the additional housing have a same external radius.

7. The electric drive unit of claim 6, wherein the components of the electrical module are disposed on at least two circuit boards,
wherein the at least two circuit boards are mutually disposed at an angle in the additional housing, and
wherein the at least two circuit boards are completely integrated in the housing wall of the additional housing.

8. The electric drive unit of claim 6, wherein the components of the electrical module are disposed on at least one circuit board that is disposed on or integrated in the additional housing,
wherein the housing wall of the additional housing configures at least one planar shelf area on which bears the at least one circuit board, and
wherein the external side of the additional housing extends radially outside the planar shelf area and the at least one circuit board in a circular manner.

9. The electric drive unit of claim 1, wherein electric contacts of the electrical module are disposed on a front end of the additional housing that faces away from the motor housing.

10. The electric drive unit of claim 1, wherein the motor housing and the additional housing are composed of a same material.

11. The electric drive unit of claim 1, wherein the motor housing and the additional housing are composed of a metal or a metal alloy.

12. The electric drive unit of claim 1, wherein the motor housing and the additional housing are screwed to one another.

13. The electric drive unit of claim 1, wherein the motor housing has a longitudinal direction, and
wherein the cooling fins of the motor housing and the additional cooling fins of the additional housing run in the longitudinal direction.

14. The electric drive unit of claim 1, wherein the electrical module forms an inverter configured to provide alternating current to the electric motor.
